(19) United States
(12) Patent Application Publication
(10) Pub. No.: US 2002/0175779 A1
(43) Pub. Date: Nov. 28, 2002

(54) Microwave crosspoint switch array with coverplate that minimizes line-to-line crosstalk

(76) Inventors: Jules D. Levine, Santa Clara, CA (US); William Clarke, Soquel, CA (US); Ross A. LaRUE, Milpitas, CA (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/864,212

(22) Filed: May 25, 2001

(51) Int. Cl. H01P 1/15

(52) U.S. Cl. 333/104; 333/262

(57) ABSTRACT

A microwave crosspoint switch array and a method of minimizing crosstalk and dispersion in such an array are provided. The array includes a substrate lower ground plane, a substrate dielectric, including a material having a first dielectric constant, at least two signal transmission lines which are deposited upon the substrate dielectric with a minimum spacing distance between the lines, and a coverplate, including a material having a second dielectric constant and a metallized upper ground plane. The material having the first dielectric constant is substantially similar to the material having the second dielectric constant. The signal transmission lines may be metallic. The second dielectric constant may differ from the first dielectric constant by less than 50%, or by less than 25%; for example, the material having the first dielectric constant may be gallium arsenide, and the material having the second dielectric constant may be alumina. The array may include an adhesive layer having a thickness and including a material having a third dielectric constant. The adhesive layer may be applied to the substrate dielectric and to the coverplate so as to structurally connect the substrate dielectric to the coverplate. The thickness of the adhesive layer may be substantially smaller than the minimum spacing of the signal transmission lines. For example, the minimum spacing of the signal transmission lines may be approximately equal to 150 μm, and the thickness of the adhesive layer may be less than 20 μm. The adhesive layer may be applied to the substrate dielectric and to the coverplate such that the adhesive layer is substantially free of air bubbles. The material having a third dielectric constant may be a thermoplastic material, such as polystyrene. The array may include as many as six or more signal transmission lines. The method may include a precision adhesion method of fusing the substrate to the coverplate.

### BACKGROUND OF THE INVENTION

1. Field of the Invention

The present invention relates to an apparatus and a method for implementing a large microwave switch array, and more particularly for minimizing line-to-line crosstalk and dispersion in a large microwave switch array.

2. Description of the Related Art

Microwave crosspoint switch arrays are used for switching between coupled microwave transmission lines. Typically, each of the microwave transmission lines is grounded in a substrate that is made from a dielectric material. When the transmission lines are completely surrounded by a uniform dielectric, the circuit is referred to as being in the homogeneous stripline configuration. Conversely, when the transmission lines are bounded partly by the dielectric substrate and partly by air, the circuit is referred to as being in a microstrip configuration. A typical material used for the dielectric substrate is gallium arsenide (GaAs).

A problem that commonly occurs with coupled microwave transmission lines is that of line-to-line crosstalk. This problem is particularly acute when the microstrip configuration is employed. A related problem is dispersion, which causes different frequency components within a signal to propagate at different speeds, thereby resulting in poor signal quality at the receive end of the transmission. The crosstalk and dispersion problems also have the effect of limiting the size of the N×N microwave switch array, because the greater the value of N, the greater the magnitude of the problem. This problem is addressed in detail in “Foundations for Microstrip Circuit Design”, T. Edwards, Second Edition, Wiley and Sons, New York, 1995, pp. 78, 205-206, and 365-372, the contents of which are incorporated herein by reference.

Both the crosstalk problem and the dispersion problem are alleviated by using the stripline configuration. However, in order to have a true stripline configuration, a uniform dielectric material must be used to bound the coupled transmission lines. This may present some mechanical problems. For example, GaAs lacks mechanical strength, as compared to some other dielectric materials. Another practical problem that can occur is the presence of air bubbles. Hence, a need for a mechanically feasible configuration that minimizes the crosstalk and dispersion problems in a microwave switch array and which allows for large switch arrays (i.e., large values of N) is presented.

### SUMMARY OF THE INVENTION

The present invention is intended to address the need for a mechanically feasible configuration that minimizes the crosstalk and dispersion problems in a microwave switch array and which allows for large N×N switch arrays, where N can be in the range 16 to 1024.

In one aspect, the invention provides a microwave crosspoint switch array. The array includes a substrate lower ground plane, a substrate dielectric, including a material having a first dielectric constant, at least two signal transmission lines which are deposited upon the substrate dielectric with a minimum spacing distance between the lines, and a coverplate, including a material having a second dielectric constant and a metallized upper ground plane. The signal transmission lines may be metallic. The material having the first dielectric constant is substantially similar to the material having the second dielectric constant. The second dielectric constant may differ from the first dielectric constant by less than 50%, or by less than 25%; for example, the material having the first dielectric constant may be gallium arsenide, and the material having the second dielectric constant may be alumina.

The array may include an adhesive layer having a thickness and including a material having a third dielectric constant. The adhesive layer may be applied to the substrate dielectric and to the coverplate so as to structurally connect the substrate dielectric to the coverplate. The thickness of the adhesive layer may be substantially smaller than the minimum spacing of the signal transmission lines. For example, the minimum spacing of the signal transmission lines may be approximately equal to 100 μm, and the thickness of the adhesive layer may be less than 20 μm. The adhesive layer may be applied to the substrate dielectric and to the coverplate such that the adhesive layer is substantially free of air bubbles. The material having a third dielectric constant may be a thermoplastic material, such as polystyrene. The array may include as many as six or more signal transmission lines.

In another aspect, the invention provides a communications switching apparatus. The apparatus includes microwave crosspoint switch array means. The apparatus includes at least a first means and a second means for transmitting a signal, substrate means for seating the at least first and second means for transmitting signals such that a minimum spacing distance is provided between the at least first and second means for transmitting signals, and coverplate means for minimizing crosstalk and dispersion and for providing structural stability to the microwave crosspoint switch array means. The substrate means includes lower ground plane means and a material having a first dielectric constant. The coverplate means includes metallized upper ground plane means and a material having a second dielectric constant. The at least first and second means for transmitting signals may be metallic. The material having the first dielectric constant is substantially similar to the material having the second dielectric constant. The second dielectric constant may differ from the first dielectric constant by less than 50%, or by less than 25%. For example, the material having the first dielectric constant may be gallium arsenide, and the material having the second dielectric constant may be alumina.

The apparatus may also include means for adhering the substrate means to the coverplate means. The means for adhering may have a thickness and include a material having a third dielectric constant. The means for adhering may be applied to the substrate means and to the coverplate means so as to structurally connect the substrate means to the coverplate means. The thickness of the means for adhering may be substantially smaller than the minimum spacing distance provided between the at least first and second means for transmitting signals. For example, the minimum spacing distance provided between the at least first and second means for transmitting signals may be approximately equal to 100 μm, and the thickness of the means for adhering may be less than 20 μm. The means for adhering may be applied to the substrate means and to the coverplate means such that the means for adhering is substantially free of air bubbles. The material having a third dielectric constant may include a thermoplastic material, such as polystyrene. The apparatus may also include at least a third, fourth, fifth, and sixth means for transmitting a signal.

In yet another aspect, a method of reducing crosstalk and dispersion in a microwave crosspoint switch array is provided. The array has N inputs and N outputs, where N is an integer greater than or equal to 2. The method includes the steps of providing N signal transmission lines, depositing the N signal transmission lines upon a substrate with a minimum spacing distance between each pair of signal transmission lines, covering the N signal transmission lines and the substrate using a coverplate, and adhering the coverplate to the substrate. The substrate includes a lower ground plane and a material having a first dielectric constant. The coverplate includes a metallized upper ground plane and a material having a second dielectric constant. The N signal transmission lines may be metallic. The material having the second dielectric constant is substantially similar to the material having the first dielectric constant. The second dielectric constant may differ from the first dielectric constant by less than 50%, or by less than 25%. For example, the material having the first dielectric constant may be gallium arsenide, and the material having the second dielectric constant may be alumina.

The step of adhering the coverplate to the substrate may include providing an adhesive layer having a thickness so as to structurally connect the coverplate to the substrate. The adhesive layer may include a material having a third dielectric constant. The thickness of the adhesive layer may be substantially smaller than the minimum spacing distance between each pair of signal transmission lines. For example, the minimum spacing distance between each pair of signal transmission lines may be approximately equal to 100 μm, and the thickness of the adhesive layer may be less than 20 μm. The step of adhering the coverplate to the substrate may be performed in a manner such that the adhesive layer is substantially free of air bubbles. The material having a third dielectric constant may be a thermoplastic material, such as polystyrene. N may be an integer greater than or equal to 6.

The step of adhering the coverplate to the substrate may include the steps of placing the substrate on a spin-on applicator machine, adding fluid of a material having a third dielectric constant, operating the machine to rotate the substrate and cause the fluid to form a first adhesive layer including a thin, uniform film across a surface of the substrate, heating the substrate and the first adhesive layer to remove solvents from the first adhesive layer, placing the coverplate on the spin-on applicator machine, adding fluid of the material having a third dielectric constant, operating the machine to rotate the coverplate and cause the fluid to form a second adhesive layer including a thin, uniform film across a surface of the coverplate, heating the coverplate and the second adhesive layer to remove solvents from the second adhesive layer, and fusing the coverplate and the substrate together such that the first and second adhesive layers are placed into contact with each other and such that the air between the first and second adhesive layers is substantially removed. The step of fusing may include the steps of using a vacuum oven to remove the air between the first and second adhesive layers, stacking the coverplate and the substrate together, heating the stacked coverplate and substrate, and placing a weight atop the stacked coverplate and substrate. Alternatively, the step of fusing may include the steps of stacking the substrate and the coverplate together on the inside of a rubberized bladder, and applying atmospheric pressure to the outside of the rubberized bladder to remove air from between the first and second adhesive layers and to solidify a bond between the first and second adhesive layers. A second alternative to the step of fusing may include the steps of stacking the substrate and the coverplate together on the inside of a rubberized bladder, and applying an overpressure to the outside of the rubberized bladder to remove air from between the first and second adhesive layers and to solidify a bond between the first and second adhesive layers. The overpressure may be approximately equal to 30 pounds per square inch.

The coverplate may include a rectangular die having a die size, and the substrate may have a substrate size that is larger than the die size such that inputs and outputs are exposed. Alternatively, the coverplate may include a wafer having a diameter, and the substrate may have a diameter equal to the diameter of the wafer. The step of adhering the coverplate to the substrate may include forming a fused disk. The method may further include the steps of scribing the fused disk into square dies, where each square die includes an upper die associated with the coverplate and a lower die associated with the substrate, and processing each square die to make the upper die smaller than the lower die such that inputs or outputs are exposed.

In still another aspect of the invention, a method is provided for simulating a stripline configuration for a microwave crosspoint switch array being used for telecommunications. The array has N inputs and N outputs, where N is an integer greater than or equal to 2. The method includes the steps of providing N signal transmission lines, depositing the N signal transmission lines upon a substrate with a minimum spacing distance between each pair of signal transmission lines, covering the N signal transmission lines and the substrate using a coverplate, and adhering the coverplate to the substrate. The substrate includes a lower ground plane and a material having a first dielectric constant. The coverplate includes a metallized upper ground plane and a material having a second dielectric constant. The material having the second dielectric constant is substantially similar to the material having the first dielectric constant.

### BRIEF DESCRIPTION OF THE DRAWINGS

FIG. 1 shows a design structure for two coupled microwave transmission lines according to the present invention.

FIG. 2 shows a plan representation of the design structure of FIG. 1.

FIG. 3 illustrates a graph of isolation as a function of coverplate height at several values of coverplate dielectric constant.

FIG. 4 illustrates a precision adhesion concept for fusing a substrate and a coverplate together according to the present invention.

### DETAILED DESCRIPTION OF THE INVENTION

The present invention addresses the need for a mechanically feasible configuration that minimizes the crosstalk and dispersion problems in a microwave switch array and which allows for large switch arrays. It is expected that a large N×N array of thyristors made on GaAs in a microstrip configuration will have serious problems related to line-to-line crosstalk and dispersion. It is shown in this invention that these problems can be eliminated by adding a coverplate that includes a layer of dielectric with ground plane on top. The particular value of the coverplate height depends on dielectric constants and geometrical input parameters. The relatively narrow range of operating parameters described in this invention corresponds to a preferred operating condition where there is ideally zero line-to-line crosstalk over the entire frequency range, and zero dispersion. In fact, the finite resistivity of the metal electrodes causes a departure from ideality, so the line-to-line crosstalk and the dispersion are very small, but not zero. This preferred operating condition can be awkward to implement on a typical MMIC device that includes a multiplicity of switches, amplifiers, and filters on the same chip. But because of the periodicity of the large N×N switch array structure, the preferred operating condition can be easily designed and implemented. Some methods of bonding the dielectric stack without entrapped air bubbles are also described, using cross-patterned thermoplastic layers, applying a weight, and then heating, under vacuum if necessary, to fuse the adhesive layers.

The major benefit is that large N×N switching arrays are possible with this invention. Otherwise, it is extremely difficult to attain this goal.

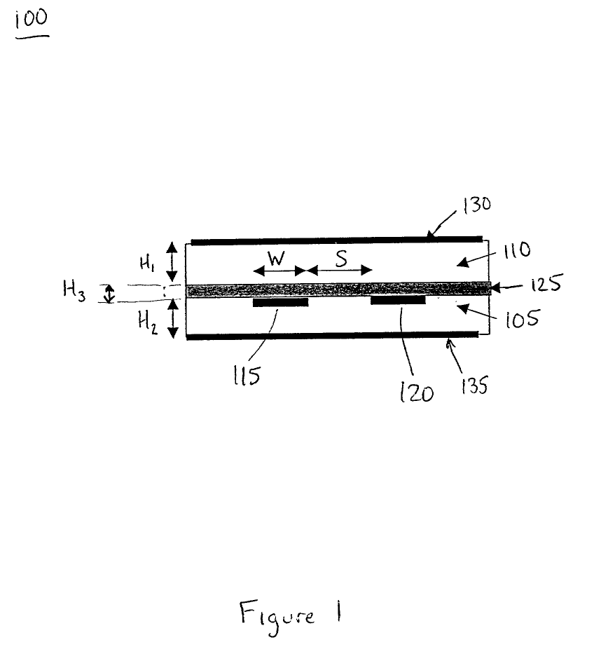

Referring to FIG. 1, a design structure 100 of two coupled microwave transmission lines is shown. This elevation figure shows a substrate 105 with dielectric constant Eᵣ₂ and a coverplate 110 with dielectric constant Eᵣ₁. If Eᵣ₁=Eᵣ₂, this is a stripline geometry. If Eᵣ₁ is not equal to Eᵣ₂, then FIG. 1 describes neither a homogeneous stripline nor a microstrip circuit bounded by air. The height of the substrate 105 is H₂, and the height of the coverplate 110 is H₁. The line widths are W, the spacing between the coupled lines is S, and the line length is L. In one example, the substrate 105 is GaAs, with Eᵣ₂=12.9, and the upper dielectric material may be the same as GaAs (i.e., homogeneous dielectric) or different from GaAs (i.e., heterogeneous dielectric). A thin and very uniform adhesive layer 125 having thickness of H₃ and a dielectric constant of Eᵣ₃ is also present. The material used for the adhesive layer 125 usually has a relatively low dielectric constant as compared to Eᵣ₁ or Eᵣ₂, so its thickness H₃ should be sufficiently small compared to S so as to minimize any perturbation of the dielectric stack.

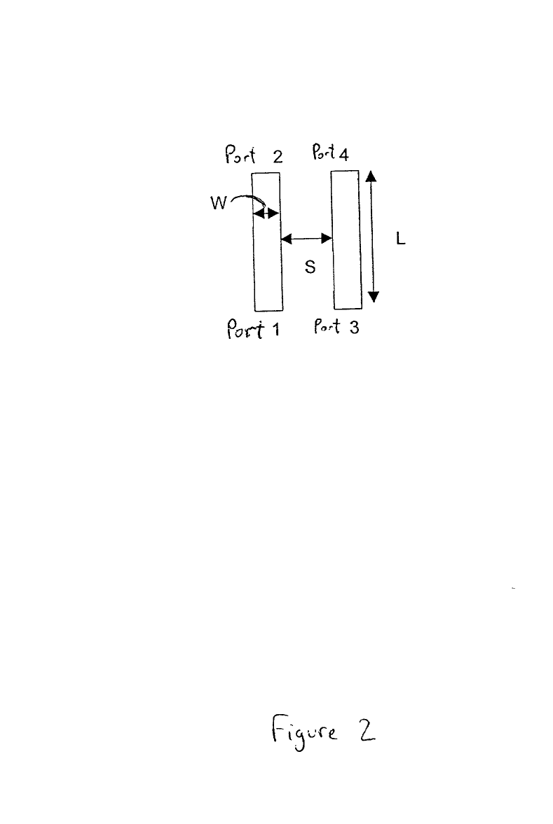

Referring to FIG. 2, a plan representation of the design structure 100 of FIG. 1 is shown. Each line has width W and length L, and the lines are spaced apart from each other by a spacing S. Port 1 is the input port, and it has a single frequency excitation. The output at port 2 is called the insertion loss, the output at port 4 is called the isolation (also referred to as “far crosstalk”), and the output at port 3 is called the coupling (also referred to as “near crosstalk”). One major problem is that for very long lines that are closely spaced, the isolation may be poor. An expression for isolation can be written as Equation 1:

Isolation=S₄₁=10 log (P₄/P₁) Equation 1

where P₄ is the microwave power in port 4, P₁ is the microwave power in port 1, and S₄₁, is the S matrix describing the power transfer from port 1 to port 4. Exemplary values include the following: H₁=4 mils; H₂=4 mils; H₃=0.5 mils, S=6 mils, L=1000 mils, W=2 mils, and N=100.

It is known that for stripline configurations where the dielectric is homogeneous (i.e., Eᵣ₁=Eᵣ₂), the isolation S₄₁ is substantially zero, independent of line length or excitation frequency. The reason for this is that a transverse electric and magnetic field (TEM) mode can exist for a homogeneous dielectric. Modeling shows that only for a specific value of H₁ does the isolation S₄₁, decrease to −45 dB, which is essentially zero. It can be shown that the dispersion is also substantially equal to zero for this condition.

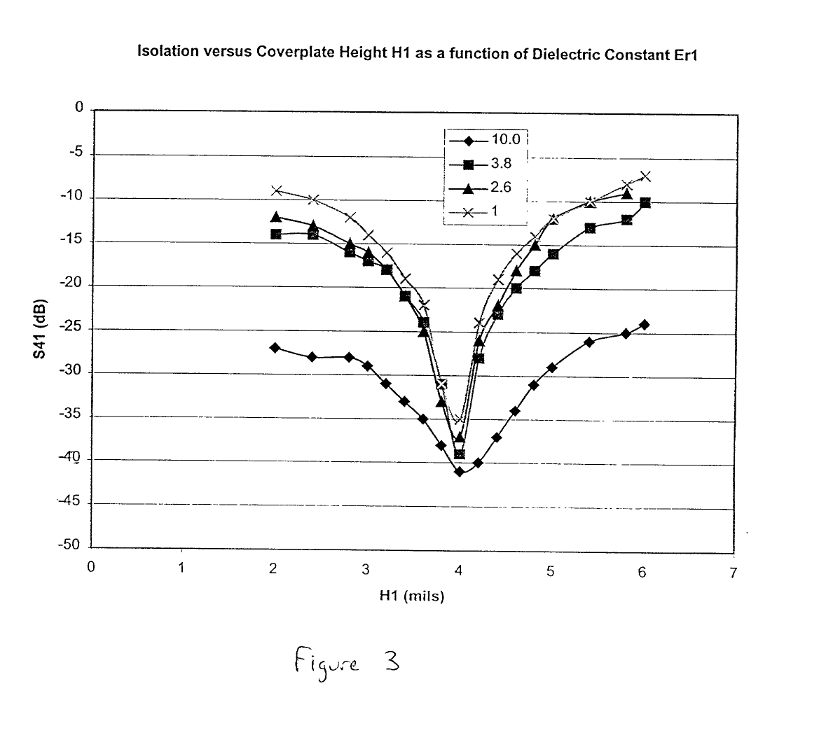

For the case in which Eᵣ₁ is not equal to Eᵣ₂, the condition of minimal crosstalk occurs, but only over a very limited range of height H₁. This is a “sweet spot” that yields minimal crosstalk and dispersion, and is independent of line length or frequency. Referring to FIG. 3, a family of curves of S₄₁ versus H₁ at several values of Eᵣ₁ is shown. In FIG. 3, S=6.0 mils and L=1000 mils on a GaAs substrate having Eᵣ₂=12.9. For each of the different values of Eᵣ₁, the value of W is adjusted to optimize isolation. Thus, for Eᵣ₁=10.0 (i.e., characteristic of alumina), W is set equal to 1.22 mils. For Eᵣ₁=3.8 (i.e., characteristic of glass), W=1.90 mils is used. For Eᵣ₁=2.6 (i.e., characteristic of benzocylcobutene (BCB)), W=2.00 mils is used. For Eᵣ₁=1.0 (i.e., characteristic of air), W=2.50 mils is used. It may be observed that for air, BCB, and glass, the sweet spot is relatively narrow, whereas for alumina, the sweet spot is relatively wide and easily achievable within engineering tolerances.

The fact that the use of alumina yields a relatively wide sweet spot, as opposed to those yielded by the use of air, BCB, or glass, is a direct result of the substantial similarity between GaAs and alumina of their respective dielectric properties. In other words, crosstalk and dispersion are minimized by choosing dielectric materials for the substrate and the coverplate, respectively, that have dielectric constants that are close in value to one another. In the examples shown in FIG. 3, the dielectric constant of GaAs is 12.9, and the dielectric constant of alumina is 10.0, which differs from 12.9 by only 22.5%. Conversely, the dielectric constant of glass is 3.8, which differs from 12.9 by 70.5%; the dielectric constant of BCB is 2.6, which differs from 12.9 by 79.9%; and the dielectric constant of air is 1.0, which differs from 12.9 by 92.3%. Hence, in this context, it may be observed that GaAs and alumina are substantially similar dielectric materials, whereas GaAs is not substantially similar to glass, BCB, or air in terms of their respective dielectric properties.

In the case of a GaAs superstrate with Eᵣ₁=Eᵣ₂=12.9, an extreme isolation value of S₄₁<−50 dB is given, provided that the conductivity of very long metal lines is sufficiently large. It is known that isolation S₄₁=0 for a homogeneous dielectric only in a lossless line. If the line is not lossless, S₄₁ is no longer zero, but it is still sufficiently small.

The effect of dispersion is to vary the propagation delays within the signal as a function of frequency. Hence, different frequency components have different delay values. This is highly detrimental to the signal quality. Dispersion can be evaluated for the design. It can be shown that dispersion is reduced when Eᵣ₁ and Eᵣ₂ are substantially equal.

Means for Attaining a Nearly TEM Mode

If the microwave design resembles a microstrip characterized by parallel signal lines on a substrate with high dielectric constant such as GaAs surrounded by air, there is no pure TEM mode, and consequently, the S₄₁ isolation is poor, especially at the high frequencies (i.e., >10 GHz) that are typically employed in this type of application. Therefore, it is an object of the invention to make the design as nearly like a stripline design as possible. Referring again, to FIG. 1, a stripline design is characterized by having parallel signal lines positioned between an upper ground plane 130 and a lower ground plane 135, with a homogeneous dielectric filling the space between the two ground planes.

In one conventional solution to the problem of minimizing S₄₁ for the stripline configuration, a metal ground plate 130 is added at a distance H₁ above the stripline substrate 105, as shown in FIG. 1, with air serving as the dielectric material 110 between the stripline and the ground plate 130, so Eᵣ₁=1.0. The metal ground plate 130 is supported at the periphery. This solution corresponds to the Eᵣ₁=1.0 curve in FIG. 3.

In a second conventional solution to the problem of minimizing S₄₁ for stripline, a thick dielectric overlay 110 having a dielectric constant Eᵣ₁ that is nearly equal to the dielectric constant Eᵣ₂ of the substrate 105 is used. In this example, it is required that H₁ is much greater than H₂. Because the dielectric overlay 110 is so thick, there is no need for a ground plane 130 atop the overlay. The problem in this case is that it is difficult to achieve epoxy bonding of the overlay material without introducing air bubbles.

In a third solution, according to a preferred embodiment of the invention, a combination of dielectric 110 and ground plane 130, such as alumina which has Eᵣ₂ approximately equal to Eᵣ₁, is employed. A homogeneous combination of GaAs substrate 105 and GaAs coverplate 110 would also work very well; this is the best strategy for minimizing crosstalk, but it has the potential disadvantage that a GaAs coverplate does not have as much mechanical strength as other coverplates, such as alumina.

In order to achieve either the second or the third solution, it is required that the adhesive layer 125 has a thickness D=H₃ that is small compared to the spacing S. In may design cases, the value of S is on the order of 150 μm, so D must be <<150 μm. A value of D which is substantially smaller than 150 μm, for example, 20 μm, should be chosen. Therefore, for example, epoxy films cannot be used, because their D is approximately equal to 100 μm.

Precision Adhesion Concept

The idea is to have a precision adhesion technique that allows the homogeneous bonding of dissimilar materials with similar dielectrics, such as GaAs and alumina, with a very thin coating of polymer. The coating should be on the order of 5-10 μm thick, and it should be free of air bubbles.

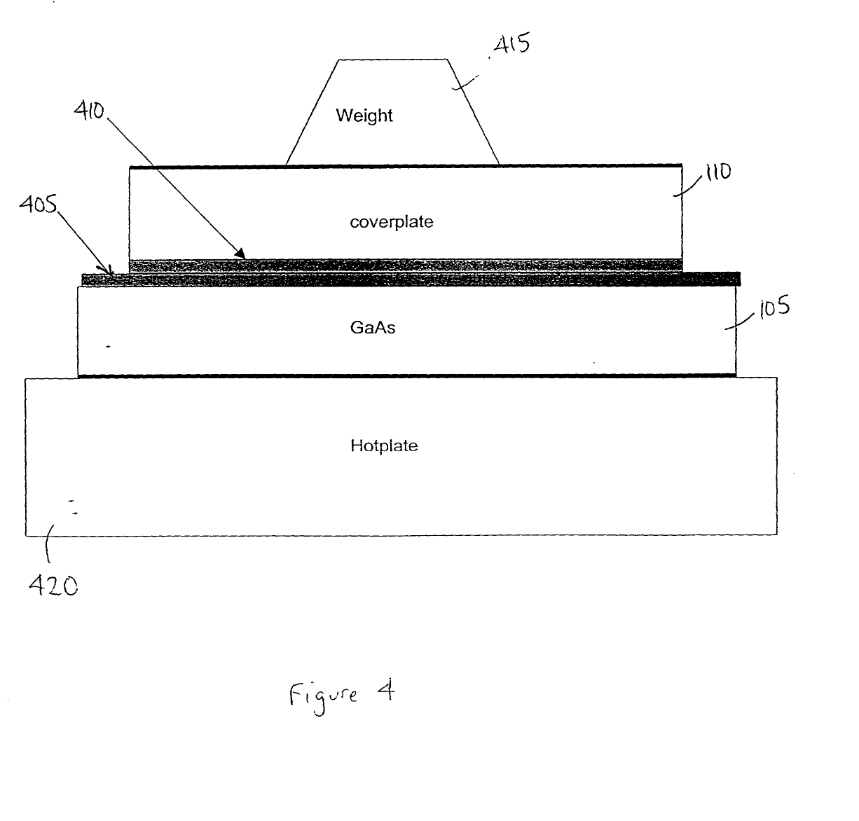

Referring to FIG. 4, the process begins by placing a substrate 105 face up on a spin-on applicator machine, and then adding excess fluid of a thermoplastic material such as polystyrene. At the rated rotational speed, the fluid polystyrene is formed into a thin uniform film having a thickness of approximately 5-10 μm across the surface. The polystyrene-coated substrate is then heated to remove solvents, thereby leaving a solid thin film of polystyrene 405 on the upper face of the substrate. The same procedure is used for the bottom face 410 of the coverplate 110.

Adhesion between the substrate 105 and the coverplate 110 is accomplished by stacking the two materials together with the coated sides 405 and 410 facing each other. The GaAs substrate may be a disk with a 7.5 cm diameter for a typical wafer, or a smaller square die having a size on the order of one square centimeter.

Prior to the fusing process, the substrate 105 and the coverplate 110 are inserted in a vacuum oven and pumped down with the coverplate separated from the substrate so that the air between them can be removed. Then the unit is heated, as indicated by the presence of the hotplate 420. It is preferred that a vacuum oven be used in place of the hotplate 420 in order to make the temperature more uniform. The heating temperature for polystyrene is only about 250° C., which is lower than the processing temperature of various dielectrics, such as BCB. Therefore, BCB can be used in a thin layer (i.e., less than 10 μm in thickness) on GaAs, which will act as an encapsulant for horizontal and vertical lines in the array.

After heating the substrate 105 and the coverplate 110 while they are still separated, they are joined together while still in vacuum, thus beginning the fusion operation. Finally, a weight 415 is applied as indicated in FIG. 4. In another preferred embodiment, atmospheric pressure is applied to the outside of a rubberized bladder that provides a differential pressure of about 14.7 psi that assists in fusing the bond. Alternatively, it is possible to apply an overpressure to the outside of a rubberized bladder such that a differential pressure of about 30 psi is provided. Under these conditions, the bond is fused without air bubbles and is very uniform, as judged by tests performed on quartz plates for the purpose of observing defects in the uniformity of bonded quartz plates, and there were none observed for a square die having an area of one square inch.

The net result of this process is an adhesive layer 125 having a thickness D=H₃ of approximately 10 μm, which is still a small fraction of the spacing S between adjacent lines, which could be on the order of about 100 μm.

Die Bond and Wafer Bond

There are two bonding strategies that can be used. The first is referred to as “die bond”, and the second is referred to as “wafer bond”.

The die bond strategy is similar to that shown in FIG. 4. An individual coverplate die is bonded to a somewhat larger individual substrate die in order to expose and bring out electrical leads at the periphery.

The wafer bond strategy involves bonding an entire wafer coverplate to the wafer substrate with both having the same diameter. After bonding, the fused disk is scribed into square dies, which may have areas on the order of one square centimeter. Each of these dies is then further processed to make the upper die smaller than the lower die, in order to expose and bring out electrical leads at the periphery. Such further processing may take place using photolithography at the periphery of the upper part of the bonded dies.

Several methods have been suggested for transforming a microstrip geometry into more of a stripline geometry, with the benefits of greatly enhanced isolation between adjacent lines. These methods rely on adhering a coverplate 110 with top metal 130 onto a substrate 105 with similar dielectric constant, so as to create a nearly TEM mode that has theoretically infinite isolation (i.e., S₄₁=0) for a lossless line. Another benefit of this invention is that the dispersion is greatly reduced for the stripline configuration, as compared to the microstrip configuration.

The net benefit is that with this invention, the isolation between lines is greatly reduced, and this allows a crosspoint analog switch to be built with a larger array size N×N than would otherwise be possible.

It is hereby noted that the best mode of the present invention entails the use of an alumina coverplate. However, while the present invention has been described with respect to what is presently considered to be the preferred embodiment, i.e., an implementation of microwave crosspoint switch array using a GaAs substrate and an alumina coverplate, it is to be understood that the invention is not limited to the disclosed embodiments. To the contrary, the invention is intended to cover various modifications and equivalent arrangements included within the spirit and scope of the appended claims. For example, it is to be understood that the coverplate may employ a different material that provides good mechanical properties and whose dielectric constant is nearly equal to that of GaAs (i.e., 12.9). The invention also may be implemented using a substrate other than gallium arsenide, with an appropriately chosen coverplate material. The scope of the following claims is to be accorded the broadest interpretation so as to encompass all such modifications and equivalent structures and functions.

What is claimed is:

1. A microwave crosspoint switch array, comprising:
a substrate lower ground plane;
a substrate dielectric, including a material having a first dielectric constant;
at least a first signal transmission line and a second signal transmission line, the signal transmission lines being deposited upon the substrate dielectric with a minimum spacing distance between the signal transmission lines; and
a coverplate, including a material having a second dielectric constant and a metallized upper ground plane,
the material having the first dielectric constant being substantially similar to the material having the second dielectric constant.

2. The array of claim 1, the at least first and second signal transmission lines being metallic.

3. The array of claim 1, wherein the second dielectric constant differs from the first dielectric constant by less than 50%.

4. The array of claim 1, wherein the second dielectric constant differs from the first dielectric constant by less than 25%.

5. The array of claim 4, the material having the first dielectric constant comprising gallium arsenide, and the material having the second dielectric constant comprising alumina.

6. The array of claim 1, further comprising an adhesive layer, including a material having a third dielectric constant, the adhesive layer having a thickness, and the adhesive layer being applied to the substrate dielectric and to the coverplate so as to structurally connect the substrate dielectric to the coverplate.

7. The array of claim 6, the thickness of the adhesive layer being substantially smaller than the minimum spacing of the signal transmission lines.

8. The array of claim 7, the minimum spacing of the signal transmission lines being approximately equal to 100 μm, and the thickness of the adhesive layer being less than 20 μm.

9. The array of claim 6, the adhesive layer being applied to the substrate dielectric and to the coverplate comprising the adhesive layer being applied to the substrate dielectric and to the coverplate such that the adhesive layer is substantially free of air bubbles.

10. The array of claim 6, the material having a third dielectric constant comprising a thermoplastic material.

11. The array of claim 10, the thermoplastic material comprising polystyrene.

12. The array of claim 1, further comprising a third signal transmission line, a fourth signal transmission line, a fifth signal transmission line, and a sixth signal transmission line.

13. A communications switching apparatus including microwave crosspoint switch array means, the apparatus comprising:
at least a first means for transmitting a signal and a second means for transmitting a signal;
substrate means for seating the at least first and second means for transmitting signals such that a minimum spacing distance is provided between the at least first and second means for transmitting signals, the substrate means including lower ground plane means and a material having a first dielectric constant; and
coverplate means for minimizing crosstalk and dispersion and for providing structural stability to the microwave crosspoint switch array means, the coverplate means including metallized upper ground plane means and a material having a second dielectric constant,
the material having the first dielectric constant being substantially similar to the material having the second dielectric constant.

14. The apparatus of claim 13, the at least first and second means for transmitting signals being metallic.

15. The apparatus of claim 13, wherein the second dielectric constant differs from the first dielectric constant by less than 50%.

16. The apparatus of claim 13, wherein the second dielectric constant differs from the first dielectric constant by less than 25%.

17. The apparatus of claim 16, the material having the first dielectric constant comprising gallium arsenide, and the material having the second dielectric constant comprising alumina.

18. The apparatus of claim 13, further comprising means for adhering the substrate means to the coverplate means, the means for adhering having a thickness and including a material having a third dielectric constant, and the means for adhering being applied to the substrate means and to the coverplate means so as to structurally connect the substrate means to the coverplate means.

19. The apparatus of claim 18, the thickness of the means for adhering being substantially smaller than the minimum spacing distance provided between the at least first and second means for transmitting signals.

20. The apparatus of claim 19, the minimum spacing distance provided between the at least first and second means for transmitting signals being approximately equal to 100 μm, and the thickness of the means for adhering being less than 20 μm.

21. The apparatus of claim 18, the means for adhering being applied to the substrate means and to the coverplate means comprising the means for adhering being applied to the substrate means and to the coverplate means such that the means for adhering is substantially free of air bubbles.

22. The apparatus of claim 18, the material having a third dielectric constant comprising a thermoplastic material.

23. The apparatus of claim 22, the thermoplastic material comprising polystyrene.

24. The apparatus of claim 13, further comprising a third means for transmitting a signal, a fourth means for transmitting a signal, a fifth means for transmitting a signal, and a sixth means for transmitting a signal.

25. A method of reducing crosstalk and dispersion in a microwave crosspoint switch array, the array having N inputs and N outputs where N is an integer greater than or equal to 2, the method comprising the steps of:
providing N signal transmission lines;
depositing the N signal transmission lines upon a substrate with a minimum spacing distance between each pair of signal transmission lines, the substrate including a lower ground plane and a material having a first dielectric constant;
covering the N signal transmission lines and the substrate using a coverplate, the coverplate including a metallized upper ground plane and a material having a second dielectric constant, the material having the second dielectric constant being substantially similar to the material having the first dielectric constant; and
adhering the coverplate to the substrate.

26. The method of claim 25, the N signal transmission lines being metallic.

27. The method of claim 25, wherein the second dielectric constant differs from the first dielectric constant by less than 50%.

28. The method of claim 25, wherein the second dielectric constant differs from the first dielectric constant by less than 25%.

29. The method of claim 28, the material having the first dielectric constant comprising gallium arsenide, and the material having the second dielectric constant comprising alumina.

30. The method of claim 25, the step of adhering the coverplate to the substrate comprising providing an adhesive layer having a thickness so as to structurally connect the coverplate to the substrate, the adhesive layer including a material having a third dielectric constant.

31. The method of claim 30, the thickness of the adhesive layer being substantially smaller than the minimum spacing distance between each pair of signal transmission lines.

32. The method of claim 31, the minimum spacing distance between each pair of signal transmission lines being approximately equal to 100 μm, and the thickness of the adhesive layer being less than 20 μm.

33. The method of claim 30, the step of adhering the coverplate to the substrate comprising adhering the coverplate to the substrate such that the adhesive layer is substantially free of air bubbles.

34. The method of claim 30, the material having a third dielectric constant comprising a thermoplastic material.

35. The method of claim 34, the thermoplastic material comprising polystyrene.

36. The method of claim 25, N being an integer greater than or equal to 6.

37. The method of claim 25, the step of adhering the coverplate to the substrate comprising the steps of:
placing the substrate on a spin-on applicator machine;
adding fluid of a material having a third dielectric constant;
operating the machine to rotate the substrate and cause the fluid to form a first adhesive layer, the first adhesive layer including a thin, uniform film across a surface of the substrate;
heating the substrate and the first adhesive layer to remove solvents from the first adhesive layer;
placing the coverplate on the spin-on applicator machine;
adding fluid of the material having a third dielectric constant;
operating the machine to rotate the coverplate and cause the fluid to form a second adhesive layer, the second adhesive layer including a thin, uniform film across a surface of the coverplate;
heating the coverplate and the second adhesive layer to remove solvents from the second adhesive layer; and
fusing the coverplate and the substrate together such that the first and second adhesive layers are placed into contact with each other and such that the air between the first and second adhesive layers is substantially removed.

38. The method of claim 37, the step of fusing comprising the steps of:
using a vacuum oven to remove the air between the first and second adhesive layers;
stacking the coverplate and the substrate together;
heating the stacked coverplate and substrate; and
placing a weight atop the stacked coverplate and substrate.

39. The method of claim 37, the step of fusing comprising the steps of:
stacking the substrate and the coverplate together on the inside of a rubberized bladder, and
applying atmospheric pressure to the outside of the rubberized bladder to remove air from between the first and second adhesive layers and to solidify a bond between the first and second adhesive layers.

40. The method of claim 37, the step of fusing comprising the steps of:
stacking the substrate and the coverplate together on the inside of a rubberized bladder, and
applying an overpressure to the outside of the rubberized bladder to remove air from between the first and second adhesive layers and to solidify a bond between the first and second adhesive layers.

41. The method of claim 40, the overpressure being approximately equal to 30 pounds per square inch.

42. The method of claim 25, the coverplate comprising a rectangular die having a die size, and the substrate having a substrate size that is larger than the die size such that inputs and outputs are exposed.

43. The method of claim 25, the coverplate comprising a wafer having a diameter, and the substrate having a diameter equal to the diameter of the wafer, the step of adhering the coverplate to the substrate comprising forming a fused disk, and the method further comprising the steps of:
scribing the fused disk into square dies, each square die comprising an upper die associated with the coverplate and a lower die associated with the substrate; and
processing each square die to make the upper die smaller than the lower die such that inputs or outputs are exposed.

44. A method of simulating a stripline configuration for a microwave crosspoint switch array being used for telecommunications, the array having N inputs and N outputs where N is an integer greater than or equal to 2, the method comprising the steps of:
providing N signal transmission lines;
depositing the N signal transmission lines upon a substrate with a minimum spacing distance between each pair of signal transmission lines, the substrate including a lower ground plane and a material having a first dielectric constant;
covering the N signal transmission lines and the substrate using a coverplate, the coverplate including a metallized upper ground plane and a material having a second dielectric constant, the material having the second dielectric constant being substantially similar to the material having the first dielectric constant; and
adhering the coverplate to the substrate.

45. The method of claim 44, the N signal transmission lines being metallic.

46. The method of claim 44, wherein the second dielectric constant differs from the first dielectric constant by less than 50%.

47. The method of claim 44, wherein the second dielectric constant differs from the first dielectric constant by less than 25%.

48. The method of claim 47, the material having the first dielectric constant comprising gallium arsenide, and the material having the second dielectric constant comprising alumina.

49. The method of claim 44, the step of adhering the coverplate to the substrate comprising providing an adhesive layer having a thickness so as to structurally connect the coverplate to the substrate, the adhesive layer including a material having a third dielectric constant.

50. The method of claim 49, the thickness of the adhesive layer being substantially smaller than the minimum spacing distance between each pair of signal transmission lines.

51. The method of claim 50, the minimum spacing distance between each pair of signal transmission lines being approximately equal to 100 μm, and the thickness of the adhesive layer being less than 20 μm.

52. The method of claim 49, the step of adhering the coverplate to the substrate comprising adhering the coverplate to the substrate such that the adhesive layer is substantially free of air bubbles.

53. The method of claim 49, the material having a third dielectric constant comprising a thermoplastic material.

54. The method of claim 53, the thermoplastic material comprising polystyrene.

55. The method of claim 44, N being an integer greater than or equal to 6.

56. The method of claim 44, the step of adhering the coverplate to the substrate comprising the steps of:
placing the substrate on a spin-on applicator machine;
adding fluid of a material having a third dielectric constant;
operating the machine to rotate the substrate and cause the fluid to form a first adhesive layer, the first adhesive layer including a thin, uniform film across a surface of the substrate;
heating the substrate and the first adhesive layer to remove solvents from the first adhesive layer;
placing the coverplate on the spin-on applicator machine;
adding fluid of the material having a third dielectric constant;
operating the machine to rotate the coverplate and cause the fluid to form a second adhesive layer, the second adhesive layer including a thin, uniform film across a surface of the coverplate;
heating the coverplate and the second adhesive layer to remove solvents from the second adhesive layer; and
fusing the coverplate and the substrate together such that the first and second adhesive layers are placed into contact with each other and such that the air between the first and second adhesive layers is substantially removed.

57. The method of claim 56, the step of fusing comprising the steps of:
using a vacuum oven to remove the air between the first and second adhesive layers;
stacking the coverplate and the substrate together;
heating the stacked coverplate and substrate; and
placing a weight atop the stacked coverplate and substrate.

58. The method of claim 57, the substrate further including a thin layer of an encapsulating material, the encapsulating material having a processing temperature lower than a temperature at which the stacked coverplate and substrate are heated in the heating step.

59. The method of claim 58, the thin layer having a thickness less than or approximately equal to 10 μm.

60. The method of claim 59, the encapsulating material comprising BCB.

61. The method of claim 56, the step of fusing comprising the steps of:
stacking the substrate and the coverplate together on the inside of a rubberized bladder, and
applying atmospheric pressure to the outside of the rubberized bladder to remove air from between the first and second adhesive layers and to solidify a bond between the first and second adhesive layers.

62. The method of claim 61, the substrate further including a thin layer of an encapsulating material, the encapsulating material having a processing temperature lower than a temperature at which the stacked coverplate and substrate are heated in the heating step.

63. The method of claim 62, the thin layer having a thickness less than or approximately equal to 10 μm.

64. The method of claim 63, the encapsulating material comprising BCB.

65. The method of claim 56, the step of fusing comprising the steps of:
stacking the substrate and the coverplate together on the inside of a rubberized bladder, and
applying an overpressure to the outside of the rubberized bladder to remove air from between the first and second adhesive layers and to solidify a bond between the first and second adhesive layers.

66. The method of claim 65, the overpressure being approximately equal to 30 pounds per square inch.

67. The method of claim 65, the substrate further including a thin layer of an encapsulating material, the encapsulating material having a processing temperature lower than a temperature at which the stacked coverplate and substrate are heated in the heating step.

68. The method of claim 67, the thin layer having a thickness less than or approximately equal to 10 μm.

69. The method of claim 68, the encapsulating material comprising BCB.

70. The method of claim 44, the coverplate comprising a rectangular die having a die size, and the substrate having a substrate size that is larger than the die size such that inputs and outputs are exposed.

71. The method of claim 44, the coverplate comprising a wafer having a diameter, and the substrate having a diameter equal to the diameter of the wafer, the step of adhering the coverplate to the substrate comprising forming a fused disk, and the method further comprising the steps of:
scribing the fused disk into square dies, each square die comprising an upper die associated with the coverplate and a lower die associated with the substrate; and
processing each square die to make the upper die smaller than the lower die such that inputs or outputs are exposed.
